(19) United States
(12) Patent Application Publication
(10) Pub. No.: US 2008/0026744 A1
(43) Pub. Date: Jan. 31, 2008

(54) Providing dynamically controlled CQI technique adapted for available signaling capacity

(75) Inventors: Frank Frederiksen, Klarup (DK); Troels E. Kolding, Klarup (DK); Per Michaelsen, Aalborg (DK); Preben E. Mogensen, Gistrup (DK); Klaus I. Pedersen, Aalborg (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/881,774

(22) Filed: Jul. 27, 2007

Related U.S. Application Data
(60) Provisional application No. 60/834,258, filed on Jul. 27, 2006.
(60) Provisional application No. 60/838,126, filed on Aug. 15, 2006.

(51) Int. Cl. H04Q 7/20

(52) U.S. Cl. 455/425

(57) ABSTRACT

In a non-limiting aspect thereof, the exemplary embodiments of this invention provide a method including sending to a user equipment information including channel quality indicator (CQI) related parameters for dynamically controlling CQI reporting of the user equipment, where the CQI related parameters are specified for the user equipment in response to information input to a network node and where the specified CQI related parameters include a reporting accuracy mode adapted for an available signaling capacity, and receiving CQI reporting from the user equipment in accordance with the CQI related parameters.

### CROSS-REFERENCE TO RELATED APPLICATIONS

This patent application claims priority under 35 U.S.C. §119(e) from Provisional Patent Application No. 60/834,258 filed Jul. 27, 2006 and Provisional Patent Application No. 60/838,126 filed Aug. 15, 2006, the disclosures of which are incorporated by reference herein in their entirety.

### TECHNICAL FIELD

The exemplary and non-limiting embodiments of this invention relate generally to wireless communication systems, methods, devices and computer program products and, more specifically, relate to techniques for sending and receiving channel quality information between user equipment and a wireless communication system network node.

### BACKGROUND

Following are some acronyms used in the description below:
3GPP third generation partnership project
UTRAN universal terrestrial radio access network
EUTRAN evolved UTRAN
OFDM orthogonal frequency domain multiplexing
Node-B base station
eNB EUTRAN Node B
UE user equipment
WCDMA wideband code division multiple access
HSDPA high speed downlink packet access
MAC medium access control
RLL radio link layer
RNL radio network layer
PHY physical (layer 1 or L1)
L2 layer 2 (e.g., the RLL/MAC layer)
L3 layer 3 (e.g., the RNL)
PDCP packet data convergence protocol
PDU protocol data unit
SINR signal to interference ratio
SN sequence number
RLC radio link controller
RRC radio resource control
RRM radio resource management
SDU service data unit
LTE long term evolution
ACK acknowledgment
NACK negative acknowledgment
UL uplink (UE to Node-B)
DL downlink (Node-B to UE)
CQI channel quality indicator
PS packet scheduler
RB resource block
PRB physical resource block
VoIP voice over internet protocol
DTX discontinuous transmission

A proposed communication system known as evolved UTRAN (E-UTRAN, also referred to as UTRAN-LTE) is at present a work item within the 3GPP. The current working assumption is that the access technique will be OFDM, which can be expected to provide an opportunity to perform link adaptation and user multiplexing in the frequency domain. In order to be able to accomplish these tasks in the frequency domain, it is important that packet scheduler and link adaptation units in the Node B have knowledge of the instantaneous channel quality. This can be achieved through the signaling of channel quality indication (CQI) reports from different UEs in the cell served by the Node B.

Ideally, the CQI reports would be available with infinite resolution and ‘zero’ delay. However, this would require the uplink signaling bandwidth to be infinite. As different UE will experience different propagation conditions, it would be desirable for the Node B to have a technique for defining/controlling the CQI reporting from each UE.

A problem that arises results from the fact that different UEs within a cell can experience different propagation conditions, and currently there is no efficient and flexible technique available such that the Node B can dynamically adjust and instruct the UE as to how many bits are allocated for uplink CQI reporting.

Currently, for CQI reporting in WCDMA/HSDPA, there is only a need for average CQI measurement reports which are each reported using a resolution of 5 bits, as the CDMA component provides an effective averaging of the channel conditions. In HSDPA it is possible for the RNC to adjust the reporting interval and potential repetition factor of the CQI reports through RRC signaling. Reference in this regard can be made specifically to 3GPP TS 25.214 V7.5.0 (May 2007), Technical Specification Group Radio Access Network; Physical layer procedures (FDD) (Release 7). Reference can be made generally to 3GPP TS 25.211 V7.2.0 (May 2007), Technical Specification Group Radio Access Network; Physical channels and mapping of transport channels onto physical channels (FDD) (Release 7), and 3GPP TS 25.306 V7.3.0 (March 2007), Technical Specification Group Radio; UE Radio Access capabilities (Release 7).

Further in regard to the usage of the uplink bandwidth for transmitting CQI information and reports, it may be assumed that the measured values are quantized to an agreed set of levels, and transmitted with a certain delay. However, the UE may be challenged to transmit the CQI reports while also facilitating high uplink traffic due at least to power limitations. Further, there may be cases with a low downlink load where it would be feasible to reduce the complexity of the uplink CQI. Further still, since data is transmitted orthogonally in the physical domain there may be limited CQI capacity at the network level, in which case the cell-level load and utilization may impact what CQI settings can be used.

The basic problem is that there is limited uplink bandwidth available for CQI signaling. While the CQI is primarily optimized for downlink performance, one should consider the case that high CQI requirements can significantly limit the uplink performance as the CQI may take a significant portion of the uplink bandwidth. In this connection it is important to note that under the current working assumptions for 3.9 G, the uplink resources are orthogonal for the allocated users as single carrier FDMA is assumed. This implies that if a UE does not fully utilize the allocated bandwidth, then the unused allocated resource is wasted as it cannot be re-used by other UE. Therefore, it is important that all users that are given resources for signaling CQI utilize these resources, and that they use the resources efficiently. The optimization of the CQI parameters for each UE thus depends at least on the per-user load conditions in both uplink and downlink, and also the cell-level load and utilization.

Methods for compression of a combined CQI message have been proposed. One such proposal is found in 3GPP TSG RAN1#43, Seoul, Korea, Nov. 7-Nov. 11, 2005, R1-051334, CQI Feedback Scheme for EUTRA, Motorola.

### SUMMARY

In an exemplary aspect of the invention, there is a method, comprising sending to a user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity; and receiving CQI reporting from the user equipment in accordance with the CQI related parameters.

In another exemplary aspect of the invention, there is a method comprising receiving at a user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity, generating CQI reporting in accordance with the CQI related parameters, and sending the CQI reporting.

In yet another exemplary aspect of the invention, there is a computer readable medium encoded with a computer program executable by a processor to perform actions comprising sending to a user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity, and receiving CQI reporting from the user equipment in accordance with the CQI related parameters.

In yet another exemplary aspect of the invention, there is a computer readable medium encoded with a computer program executable by a processor to perform actions of a user equipment comprising receiving at the user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity, generating CQI reporting in accordance with the CQI related parameters, and sending the CQI reporting.

In yet another exemplary aspect of the invention, there is an apparatus, comprising a wireless transmitter coupled to a processor configured for sending to a user equipment information comprising channel quality indicator (CQI) related parameters for dynamically controlling CQI reporting of the user equipment, where the CQI related parameters are specified for the user equipment in response to information input to the apparatus and where the specified CQI related parameters comprise a reporting accuracy mode adapted for an available signaling capacity, and a receiver for receiving CQI reporting from the user equipment in accordance with the CQI related parameters.

In another exemplary aspect of the invention, there is an apparatus comprising a wireless receiver configured to receive at a user equipment information comprising channel quality indicator (CQI) related parameters for dynamically controlling CQI reporting of the user equipment, where the CQI related parameters are specified for the user equipment in response to information input to the apparatus and where the specified CQI related parameters comprise a reporting accuracy mode adapted for an available signaling capacity, a processor configured to generate CQI reporting in accordance with the CQI related parameters, and a transmitter configured to send the generated CQI reporting.

In still another exemplary aspect of the invention there is an apparatus, comprising means for sending to a user equipment information comprising channel quality indicator (CQI) related parameters for dynamically controlling CQI reporting of the user equipment, where the CQI related parameters are specified for the user equipment in response to information input to the apparatus and where the specified CQI related parameters comprise a reporting accuracy mode adapted for an available signaling capacity, and means for receiving CQI reporting from the user equipment in accordance with the CQI related parameters. In a particular embodiment the means for sending comprises a transmitter coupled to a processor; and the means for receiving comprises a receiver.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention;

FIGS. 2 and 3 illustrate exemplary RRC modes for the CQI accuracy modes, and exemplary RRC modes for controlling time domain reporting setup, respectively;

FIG. 4 shows a logic flow diagram that is illustrative of a method, and an operation of a computer program product, in accordance with the exemplary embodiments of the invention;

FIG. 5 shows a logic flow diagram that is illustrative of an exemplary method to establish a set of UE CQI-related parameters for dynamically adjusting CQI reporting accuracy and bandwidth usage, and to transmit the set of CQI-related parameters into a cell to a specific UE or to a plurality of UEs;

FIG. 6 shows a simplified block diagram of the UE and Node B of FIG. 1 showing PHY, MAC and RRC protocol stack layers and the signaling between them, where overall CQI control is located in the Node-B and the means for adapting the CQI parameters is provided at the level of the RRC (as a non-limiting example);

FIG. 7 shows a graph depicting how the CQI bandwidth may be adjusted according to the monitored/measured downlink and uplink radio utilization (at both the user and cell level); and

FIG. 8 shows a logic flow diagram that is illustrative of operation of the CQI Control mechanism shown in FIGS. 1 and 6.

### DETAILED DESCRIPTION

The exemplary embodiments of this invention address the foregoing and other problems, and provide a CQI reporting scheme wherein the Node B is enabled to instruct a UE to switch between CQI measurement reporting modes.

The exemplary embodiments of this invention further address the foregoing and other problems, and provide a readily modifiable CQI scheme in LTE that may be configured over time.

The exemplary embodiments of this invention further address the foregoing and other problems by providing for modifying a CQI scheme based on both the downlink and the uplink load of the link and the cell.

The exemplary embodiments of this invention provide a CQI technique that is flexible and allows for simple parameter configuration by the Node B, and further provide a CQI technique that readily scales from distributed multiplexing support to advanced packet scheduling. The exemplary embodiments of this invention provide a CQI technique having a bandwidth that is adjustable to match the available signaling capacity by the UE. In one non-limiting aspect thereof the CQI technique in accordance with the exemplary embodiments includes a parameter framework in combination with a method to interpret the parameters in the UE.

In one approach those users that are experiencing rapidly changing radio conditions may be scheduled using a technique known as distributed transmission, meaning that since the Node B only needs a measure of the average experienced SINR at the UE, a simple reporting method could be used. For low mobility users, the Node B may benefit from frequency domain scheduling, and in this case the Node B would benefit more from having detailed measurement reports in the frequency domain. It may be so that for some channel conditions it is sufficient to transfer a bit map indicating which resource blocks are in favorable conditions, while in other situations it is desirable to have the full report of the relative SINR of each physical resource block. The exemplary embodiments of this invention provide a mechanism to support these and other CQI-related features.

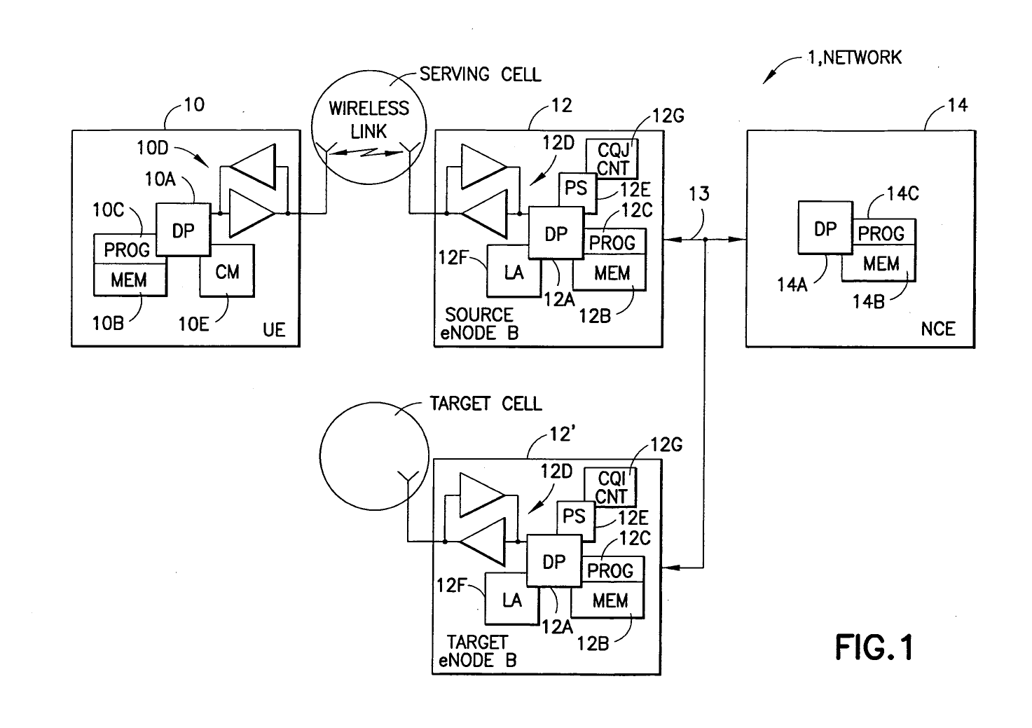

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via at least one Node B (base station) 12 also referred to herein as an eNode B 12.

The network 1 may include a Network Control Element (NCE) 14 coupled to the eNode B 12 via a data link 13. The UE 10 includes a data processor (DP) 10A, a memory (MEM) 10B that stores a program (PROG) 10C, and a suitable radio frequency (RF) transceiver 10D (e.g., a receiver and a transmitter) for bidirectional wireless communications with the eNode B 12, which also includes a DP 12A, a MEM 12B that stores a PROG 12C, and a suitable RF transceiver 12D. The eNode B 12 is coupled via the data path 13 to the NCE14 that also includes at least one DP 14A and a MEM 14B storing an associated PROG 14C. At least one of the PROGs 10C and 12C is assumed to include program instructions that, when executed by the associated DP, enable the electronic device to operate in accordance with the exemplary embodiments of this invention, as will be discussed below in greater detail.

Shown for completeness in FIG. 1 is at least one second eNode B, referred to as 12′. During a HO event the eNode B 12 may be considered the Source eNode B, i.e., the eNode B to which the UE 10 is currently connected and communicating in the associated serving cell, and the eNode B 12′ may be considered the Target eNode B, i.e., the eNode B to which the UE 10 is to be connected and communicating with in the target cell after the HO procedure is completed. Note that in practice the serving cell and the target cell with at least partially overlap one another. The UE 10 will typically experience different RF channel propagation conditions as it moves within a given cell, and well as from cell-to-cell.

Each eNode B 12, 12′ may be assumed to include a packet scheduler (PS) function or unit 12E, and possibly also a link adaptation (LA) function or unit 12F. Each eNode B 12, 12′ may be assumed to include a CQI Control (CQI CNT) function or entity 12G that is constructed and operated in accordance with the exemplary embodiments of this invention, as discussed in greater detail below. The UE 10 may be assumed to include a channel measurement (CM) function or unit 10E with which it may generate at least CQI information to be sent to the eNode B 12, as specified by a received set of CQI-related parameters and instructions as described in detail below in accordance with exemplary embodiments of this invention.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 12A of the eNode Bs 12 and 12′, or by hardware, or by a combination of software and hardware.

The MEMs 10B, 12B and 14B may be of any type suitable to the local technical environment and may be implemented using any suitable data storage technology, such as semiconductor-based memory devices, flash memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Describing an exemplary embodiment of this invention in further detail, there are defined a set of RRC states that define the CQI reporting mode. As a non-limiting example, two different modes are defined: an accuracy mode and a reporting mode. Each mode may be partitioned into a plurality of states. For example, the accuracy mode may be partitioned into three distinct states: “Distributed measurement”, “Localized bit map”, and “Localized individual reports”. In this manner the Node B 12 is enabled to adjust the reporting mode of each UE 10 such that it can make the best compromise between, as non-limiting examples, uplink traffic load, UE mobility, and a desired multiplexing freedom in the Node B 12. Furthermore, the RRC states could also be used to configure time domain triggers for when and how the UE 10 should deliver the CQI measurement reports.

By “desired multiplexing freedom” of the Node B 12 what is implied is that accuracy of the CQI measurement reports have the potential to impact the freedom that the packet scheduler 12D and link adaptation 12F have in connection to selecting users for scheduling. In the case of detailed CQI reporting for all users, one may have near perfect knowledge of each user's propagation conditions, and can select optimally which users (UEs 10) to schedule on which frequency sub-bands. However, if only bitmap information is available, the Node B 12 will have knowledge of which frequency sub-bands are ‘good’ (e.g., those set to a one in the bitmap)and which are ‘bad’ (e.g., those set to a zero in the bitmap). Without additional information the Node B 12 scheduler may employ the bitmap reports so as to use only the subset of the sub-bands reported as being ‘good’. In this case it can be seen that the Node B 12 can experience limited multiplexing or scheduling freedom in assigning users to frequency sub-band resources.

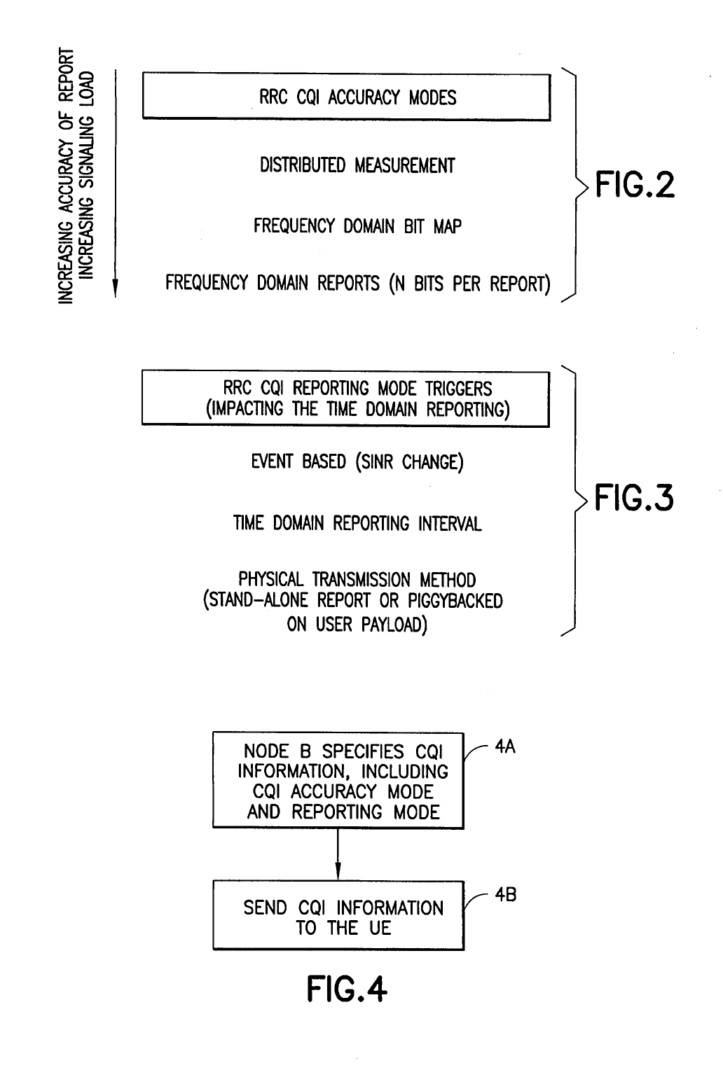

FIGS. 2 and 3 illustrate exemplary RRC modes for the CQI accuracy modes, and exemplary RRC modes for controlling time domain reporting setup, respectively. Note that the states shown in FIG. 2 would typically be mutually exclusive, whereas modes shown in FIG. 3 may be controlled individually and need not be mutually exclusive.

Describing FIGS. 2 and 3 now in greater detail, FIG. 2 shows exemplary RRC states for controlling the accuracy of the UE 10 CQI reporting. Consider as an example a deployment scenario where there are a number of VoIP users in a cell, as well as several high data rate users engaged in, for example, FTP download or extensive web browsing activities. As the VoIP UEs 10 would typically wish to limit power consumption so as to extend their talk time, they would desire to report CQI as seldom as possible. Further, since the VoIP UEs 10 are only ‘on’ every 20^{th} ms, the CQI reports from these UEs will generally be quite old. As these UEs 10 would not generally benefit from frequency domain scheduling, the CQI CNT 12G of the Node B 12 may typically target them for distributed transmission. Thus, these UEs may report a simple estimate of the path loss (or a measure of the average experienced SINR at each UE) using a relatively small CQI report format (e.g., a 5-bit CQI report may be sufficient to report the path loss or average SINR to the Node B 12).

It should be noted that CQI reporting may in fact be reporting a supported throughput, as opposed to the SINR per se. This may be the case since the throughput is typically easier to test and verify and furthermore, the SINR can be impacted by a number of factors, including a specific receiver implementation. Thus, while the exemplary embodiments of this invention are described in the context of the use of the SINR, it should be appreciated that typically a direct mapping will exist or can be derived between the SINR and the supported throughput in a CQI report. As such, while described in the context of the use of the SINR, it should be appreciated that even more generally a CQI metric of interest may be throughput, or some factor related to throughput and not the SINR per se.

However, for the case of the high data rate UEs 10 it would be desirable to optimize their peak throughput and spectral efficiency, and the CQI CNT 12G of the Node B 12 may place them into a localized reporting mode such that the frequency domain information for these high data rate UEs 10 is available for fast scheduling, thereby allowing for frequency domain multiplexing of these UEs 10.

In this manner the Node B 12 may balance the uplink traffic for each UE 10 to the current operational mode. Similarly, the Node B 12 can implement triggers for when and how to perform the UL CQI reporting, such that the Node B 12 has full control of the reporting occasions and the utilization of the limited UL control signaling bandwidth. In this manner it also becomes possible to implement a Node B feature such as ‘constant bandwidth allocation’ for uplink control signaling.

Note that in FIG. 2 the exemplary RRC CQI accuracy modes that may be selected by the CQI CNT 12G of the Node B 12 include, in order of increasing report accuracy and increasing UL signaling load: the distributed measurement mode, a frequency domain bit map with one bit per frequency domain report, and frequency domain reports with N bits per frequency domain report.

Note that in FIG. 3 the exemplary RRC CQI reporting mode triggers that impact time domain reporting that may be selected by the CQI CNT 12G of the Node B 12 include: event based triggers (e.g., one based on a change of SINR by some threshold amount), a time domain reporting interval and/or the physical transmission method (e.g., the CQI report is sent as a dedicated CQI report or it is piggybacked in some mutually agreed fashion on the user payload or possibly on some non-CQI UL signaling message.

In the cases of both FIGS. 2 and 3 it can be appreciated that the UE 10 is operable to receive and respond to the DL CQI-related signaling from the Node B 12, and to operate the CM 10E and other CQI-related circuits/programs so as to provide the desired CQI report to the Node B 12 at the specified times/intervals, and in the specified physical format.

An advantage that is derived from the use of the foregoing exemplary embodiments is that the CQI can be configured for each UE 10 while taking into account cell-level aspects such as, but not limited to, cell load of a UL and/or DL, and/or multi-user aspects.

Referring also to FIG. 4, it should be appreciated that the exemplary embodiments of this invention, in one aspect thereof, provide a method for a network node, such as the Node B 12, to specify CQI-related information, such as a desired CQI accuracy mode and at least one desired CQI reporting mode (Block 4A), and to send this specified CQI information to the UE 10 via DL signaling (Block 4B).

In the method, specifying the CQI information may comprise a consideration of one or more of, as non-limiting examples, uplink traffic load, UE mobility, a type of UE traffic, UE power consumption considerations and a number of UEs in a cell of the Node B.

In the method, the CQI accuracy mode may include a plurality of mutually exclusive modes or sub-modes, comprising: a distributed measurement mode, a frequency domain bit map mode, and N-bit frequency domain reports.

In the method, the CQI reporting mode may include a plurality of modes or sub-modes, comprising: event based, time domain reporting interval, and may also specify a type of physical CQI report transmission method.

Also disclosed is a mobile node, such as the UE 10, that is responsive to receiving the DL signaling of the CQI-related information for operating in accordance therewith for reporting CQI-related information to the network node.

The DL signaling from the Node B 12 is preferably accomplished through the use of specified signaling message(s) and message formats, such as those agreed to as per standardization, and may be dedicated messages(s) for this purpose, or the CQI information may be incorporated into other DL control signaling sent from the Node B 12 to the UEs 10. Note that since the CQI information is typically specific to the operational status/needs of a given UE 10, it may be desirable to send the CQI information in a point-to-point manner. However, it is within the scope of the exemplary embodiments to also use a point-to-multipoint DL transmission, such as if sending a specific set of CQI information such as accuracy and reporting mode information to a sub-set of the UEs 10 such as those UEs involved in VoIP communication.

Further in accordance with the exemplary embodiments of this invention, there is provided a computer program product (e.g., 12C, 12G) embodied on a tangible computer-readable medium (e.g., 12B) the execution of which by a data processor (e.g., 12A) results in operations that comprise specifying CQI-related information, comprising a desired CQI accuracy mode and at least one desired CQI reporting mode, and sending the specified CQI information to the UE 10 via DL signaling.

Further in accordance with the exemplary embodiments of this invention, there is provided a Node B that comprises a unit, responsive to at least one input, to specify CQI-related information, comprising a desired CQI accuracy mode and at least one desired CQI reporting mode, and a transmitter to send the specified CQI information to the UE 10 via DL signaling. The at least one input may comprise, as non-limiting examples, uplink traffic load, UE mobility, a type of UE traffic, UE power consumption considerations and a number of UEs in a cell of the Node B. The CQI accuracy mode may include a plurality of mutually exclusive modes or sub-modes, comprising: a distributed measurement mode, a frequency domain bit map mode, and N-bit frequency domain reports, the CQI reporting mode may include a plurality of modes or sub-modes, comprising: event based, time domain reporting interval, and may also specify a type of physical CQI report transmission method.

Also disclosed is a mobile node, such as the UE 10, that is responsive to receiving the DL signaling of the CQI-related information for operating in accordance therewith for reporting CQI-related information to the network node.

Describing now further exemplary embodiments of this invention in further detail, certain CQI-related parameters are transmitted from the eNode B 12 to the UE 10. The parameters may be transmitted per-UE signaling (point-to-point), by broadcast signaling (point-to-multipoint), or by incorporating into other DL control signaling sent from the Node B 12 to the UEs 10. Note that since the CQI information is typically specific to the operational status/needs of a given UE 10, it may be desirable to send the CQI information in a point-to-point manner. However, it is within the scope of the exemplary embodiments to also use a point-to-multipoint DL transmission, such as if sending a specific set of CQI information to a sub-set of the UEs 10 (e.g., all those UEs involved in VoIP communication.)

The eNode B 12 is thus enabled to dynamically adjust the reporting accuracy and bandwidth through the use of three basic parameters referred to for convenience, and not by way of limitation, as: N_{ActiveRB} (Number of Active Resource Blocks), Y, and R_{CQI}. Based on the values of these parameters the CQI measurement and the CQI message size is specified. These three parameters are defined as follows.

N_{ActiveRB}: a bit mask identifying what PRBs the UE 10 is to conduct its measurements on. This aspect of the exemplary embodiments of the invention is discussed in further detail below. The bit mask has a length corresponding to the number of RBs. In this manner the UE 10 can be requested to report its channel quality only for a subset of the PRBs. For example, the more zeros that are present in the mask the less signaling bandwidth is required.

Y: a number denoting how many neighboring PRBs should be “grouped” together and averaged out in the measurement. Note that neighboring here relates to the “1s” in the bit mask N_{ActiveRB}. If Y equals length (N_{ActiveRB}), what is present is a technique supporting distributed transmission only on the masked-out PRBs. Y may be viewed as a “clustering” factor.

R_{CQI}: a number indicating how many representation bits are available per signaling N_{activeRB}/Y group. One may define a SINR threshold, dynamic range from the best RP, over which the bits are distributed. For example, one may define this threshold as DTH and assume that it is a cell-level parameter, although it may be specified also per user link. The value of this parameter may range from, as one non-limiting example, ‘0’ to ‘5’ for specifying operations ranging from disabling frequency domain reporting in the case of ‘0’ for no per-PRB information, to bit map reporting for a value of ‘1’ (e.g., is the PRB within or out of the range defined by the threshold). More bits allow for accurate SINR descriptions for each PRB, which can be useful for a Frequency Division Packet Scheduler (FDPS) 12E.

Given the above parameters, the size of the CQI report is now defined and can be calculated as:
N_{CQI}=M_{CQI}+(length{N_{activeRB}}/Y}×R_{CQI},
where M_{CQI} is the number of bits allocated for signaling of the average relative SINR value (or a similar metric representing the average channel quality). This metric may be fixed in the network 1 (e.g., 5-6 bits). Furthermore, the scaling factor (N_{activeRB}/Y) may be used to further adjust the reporting accuracy.

Illustrative examples are given in the following, which assume as a non-limiting case the use of a 10 MHz system bandwidth with 24 PRBs.

### EXAMPLE 1

Assume a case were it is desired to have FDPS in a favorable microcell environment where three, to match the value of Y, neighboring PRBs can be assumed to have the same channel conditions well within coherence bandwidth. Also assume that it is desired to have 3 bits for every PRB in the system, thus defining 8 SINR levels from the best PRB within DTH, including out-of-range. The CQI parameters may thus be set as:
1. N_{ActiveRB}=[111111111111111111111111] (all PRBs are selected),
2. Y=3 (that is, the UE 10 is to combine three neighboring PRBs), and
3. R_{CQI}=3.

### EXAMPLE 2

Assume a case where there is an uplink limited high-velocity UE 10 using VoIP needing only, on average, two PRBs for transmission. In this case the CQI bandwidth may be limited by requesting the UE 10 to only report for two different PRBs, and to always use distributed transmission always for the user. In this case knowledge of the differences between the PRBs is not required, but instead just the average SINR. The CQI parameters may thus set as:
1. N_{ActiveRB}=[000010000000000000001000] (two selected PRBs),
2. Y=2 (average the measurement of the two PRBs (neighboring as Is in the mask), and
3. R_{CQI}=0.

### EXAMPLE 3

Assume the case of an uplink limited low-velocity UE 10 using VoIP and needing, on average, only two PRBs for transmission. Due to cell conditions it may still be desirable to use FDPS to achieve multiplexing gain for a number of low data rate users. In this case the CQI bandwidth can be limited by reducing the frequency diversity order selecting four PRBs whereas two are needed for data, and requesting the UE 10 to report back approximate SINR differences between the PRBs allocating 2 bits to divide the range into four levels, including out-of-range. The CQI parameters may thus be set as:
1. NActiveRB=[10000001000000010000001] (four selected PRBs),
2. Y=1. (provide a measurement for each PRB), and
3. R_{CQI}=2.

These three examples of the use of the exemplary embodiments of this invention are clearly not intended to be limiting as to the use and practice of the exemplary embodiments of this invention.

The foregoing techniques provide an efficient and scalable CQI framework for trading off downlink performance with uplink signaling bandwidth. The set of RRC parameters provide a flexible approach to addressing various proposed CQI concepts in a simple way, and provide for an efficient encoding and decoding of the CQI parameters.

It should be noted that the foregoing parameters can be given as cell-specific parameters common to each cell, or they may be given/defined on a per-user or per UE 10 basis, so as to optimize the trade off between uplink and downlink traffic. If the parameters are employed on a per-user basis the signaling may be performed through a robust signaling protocol such as the RRC.

Advantages that are realized by the use of the foregoing exemplary embodiments of this invention include the ability for the Node B 12, such as via the CQI CNT function 12G, to be in full control of the CQI reporting accuracy and corresponding bandwidth occupancy for each UE 10, thus enabling the Node B 12 to establish an optimum balance between UE 10 mobility, data traffic and spectral efficiency.

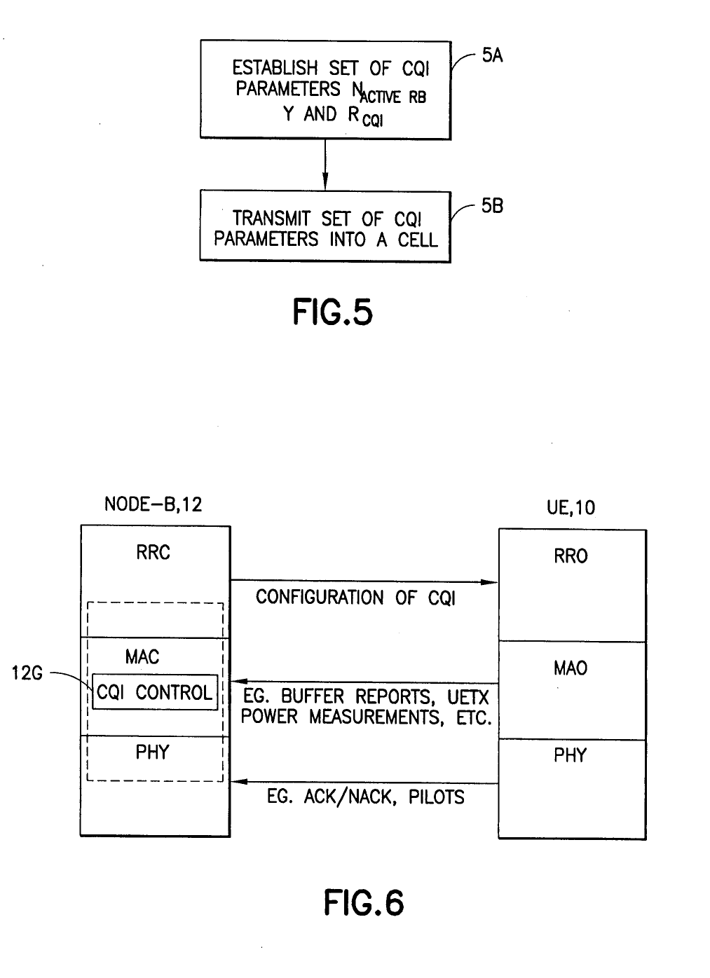

In accordance with a method, and referring to the logic flow diagram of FIG. 5, at Block 5A a network element (e.g., the eNode B 12) establishes a set of UE CQI-related parameters for dynamically adjusting CQI reporting accuracy and bandwidth usage, where the CQI-related parameters comprise: N_{ActiveRB} (a bit mask for specifying a Number of Active Resource Blocks), Y (a clustering factor), and R_{CQI} (for indicating how many representation bits are available per signaling N_{activeRB}/Y group), thereby specifying the CQI measurement and the CQI message size. At Block 5B the set of CQI-related parameters are transmitted into a cell to a specific UE 10 or to a plurality of UEs 10.

In the method a length of the bit mask N_{ActiveRB} corresponds to a number of RBs. In the method the value of Y specifies how many neighboring PRBs are grouped together and averaged in making the CQI measurement, where “neighboring” relates to those bits set to a one in the bit mask N_{ActiveRB}, and where if Y equals length(N_{ActiveRB}) distributed transmission only on the masked-out PRBs is supported. In the method, and related to R_{CQI}, a SINR threshold DTH may be defined as one of a cell-level parameter or as a per UE 10 link parameters.

In the method the size of a CQI report is defined as:
N_{CQI}=M_{CQI}+(length{N_{activeRB}}/Y}×R_{CQI},
where M_{CQI} is the number of bits allocated for signaling of a metric indicative of average channel quality, such as an average relative SINR value.

The exemplary embodiments of this invention also pertain to a network element, such as the eNode B 12, that comprises at least one functional unit (such as the CQI CONT function 12G) to establish a set of UE CQI-related parameters for dynamically adjusting CQI reporting accuracy and bandwidth usage, where the CQI-related parameters comprise: N_{ActiveRB} (a bit mask for specifying a Number of Active Resource Blocks), Y (a clustering factor), and R_{CQI} (for indicating how many representation bits are available per signaling N_{activeRB}/Y group), thereby specifying the CQI measurement and the CQI message size. An output of the functional unit is coupled to a transmitter to transmit the set of CQI-related parameters into a cell to a specific UE 10 or to a plurality of UEs 10.

The exemplary embodiments of this invention also pertain to a computer program product (12C), embodied in a tangible memory medium (12B), the operation of which results in establishing a set of UE CQI-related parameters for dynamically adjusting CQI reporting accuracy and bandwidth usage, where the CQI-related parameters comprise: N_{ActiveRB} (a bit mask for specifying a Number of Active Resource Blocks), Y (a clustering factor), and R_{CQI} (for indicating how many representation bits are available per signaling N_{activeRB}/Y group), thereby specifying the CQI measurement and the CQI message size; and for causing the set of CQI-related parameters to be transmitted into a cell to a specific UE 10 or to a plurality of UEs 10. In this case the CQI CNT function 12G may be implemented in whole or in part by the computer program product 12C.

The foregoing exemplary embodiments of this invention pertain as well to a UE-executed method, a UE computer program product (10C), and a UE 10 that is capable of receiving the transmitted set of CQI-related parameters, of decoding the received set of CQI-related parameters, and of formulating and reporting to the eNode B 12 a CQI measurement, made by the channel measurement (CM) function or unit 10E, as specified by the received and decoded set of CQI-related parameters.

Discussing now further exemplary embodiments of this invention, an aspect thereof employs at least one of per-link uplink and downlink load measurements, a QoS service profile, and a cell-level downlink and uplink load/utilization into account when adapting the CQI parameters for each individual UE. The entity that performs these tasks can be located in the Node B 12, such as the CQI CNT function 12G, and which may also consider other means of adaptation discussed for LTE (e.g., “speed” dependent CQI). For the implementation of these exemplary embodiments a stable means for communicating the CQI parameters between the Node B 12 and the UE 10 is assumed (e.g., RRC signaling).

To illustrate the general principle, consider FIG. 6 which shows an example implementation incorporating both the UE 10 and the Node B 12. It is assumed that the CQI technique can be updated by means of control commands exchanged between the Node B 12 and the UE 10. Exemplary CQI parameters could, for example, be based on existing WCDMA/HSDPA parameters, as well as those proposed for LTE, and may include: the transmission rate of the CQI report (e.g., how often is it sent), the format of the CQI report (e.g., if only a simple wideband measurement is needed, or if a detailed per resource block reporting is desired), and a reporting repetition factor where one may reduce the CQI transmission power and retransmit it several times in the uplink to ensure reliable transmission.

Further in accordance with the exemplary embodiments, physical resource conditions for the UE 10 can be employed. For example, it may be specified that the reporting be done for certain specified frequency resource blocks, as was explained in detail above with regard to the use of the set of UE CQI-related parameters for dynamically adjusting CQI reporting accuracy and bandwidth usage, where the CQI-related parameters may comprise: N_{ActiveRB}, Y and R_{CQI}. The use of these exemplary CQI-related parameters is beneficial in that it improves the efficiency of the load-dependent CQI adaptation scheme.

In FIG. 6 one may assume that the update of the CQI reporting method is done via RRC signaling, however CQI reporting may be updated directly based on MAC/PHY layer signaling if so desired.

The CQI control entity in the Node B 12 such as the CQI CNT function 12G may also update the CQI parameters based on inputs such as an estimation of the CQI rate of change. In this approach, and by example, if the CQI is unstable over time it may be desirable to switch the CQI scheme to a distributed one, or if the CQI changes very slowly the signaling rate may be reduced or frequency-domain resolution of the CQI can be increased at the expense of time-domain resolution.

Another input that may be considered by the CQI control entity in the Node B 12 is an estimation of uplink channel quality conditions. For example, if the UE 10 is coverage limited, the network may decide to introduce CQI repetition in the uplink, or reduce the CQI complexity, in order to improve the ability of the UE 10 to transmit the CQI report successfully.

In addition to the foregoing considerations, the exemplary embodiments of this invention also may consider and may use at least the following per-link and per-cell measures and criteria.

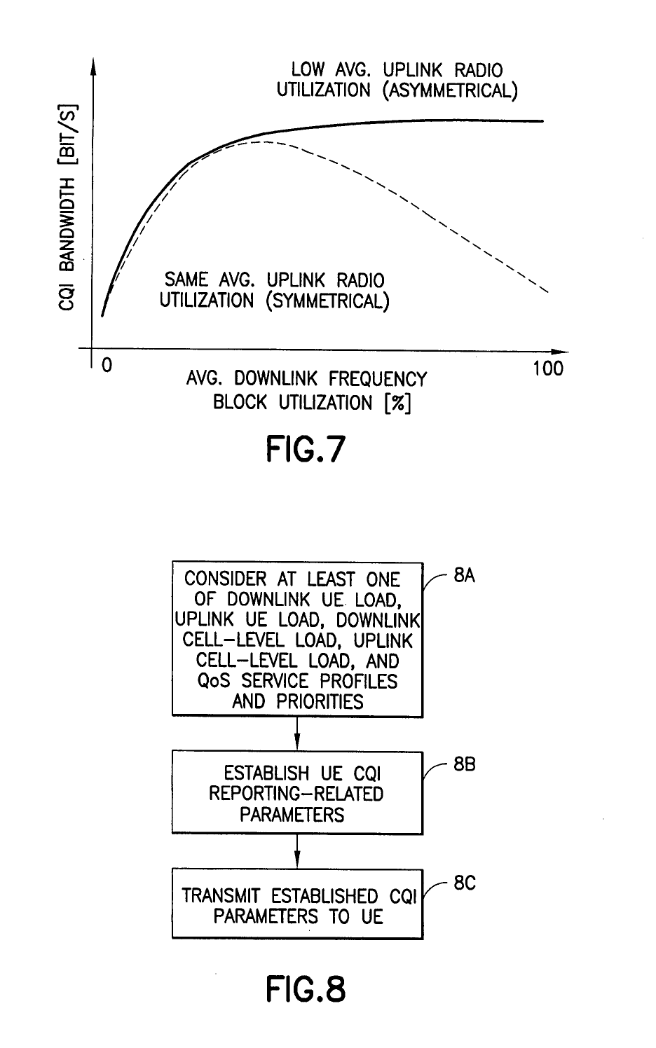

One criterion of interest is the downlink load for the UE 10 and consumed radio resources. In this regard if only a small data amount needs be sent in the downlink, and channel quality is sufficient such that only few frequency resource blocks are used, the CQI may be reduced in complexity to just include the channel quality on a selected few frequency resource blocks (see the left portion of FIG. 7). Further by example, if the uplink utilization is low and the downlink utilization is high (e.g., asymmetrical traffic, exemplified in FIG. 7 in the right-hand side (high utilization) for the case with high load asymmetry (asymmetrical case)), one may increase the CQI bandwidth in order to maximize the spectral efficiency in the downlink.

For example, the download can be made faster, but more uplink transmission power is consumed to achieve gain. That is, ideally the UE 10 is enabled to more rapidly complete the data transfer, and is subsequently allowed to enter into a power-save mode (DRX) to reduce the impact on overall battery performance. The CQI control entity 12G in the Node B 12 may further coordinate this with knowledge of DRX cycles or other means of “pre-known” allocations in the downlink direction.

Another criterion of interest that may be considered by the CQI control entity 12G in the Node B 12 is the uplink load for the UE 10, and the consumed radio resources. Further in this regard it may be appreciated that if a large amount of user data needs to be sent in the uplink, and power resources are scarce, one may reduce the complexity of the CQI report (e.g., balancing the performance between uplink and downlink). This is exemplified in FIG. 4 in the right-hand side (high utilization) for the case with high load symmetry (symmetrical case).

Another criterion of interest that may be considered by the CQI control entity 12G in the Node B 12 is the downlink cell-level load and utilization. For example, if there are many UEs 10 present in the cell, and frequency domain packet scheduling is in use with many UEs 10 being multiplexed simultaneously, one may reduce the CQI bandwidth for each UE 10 (e.g., lowering the user diversity order which results in less of an effect if the diversity order is high initially).

Another criterion of interest that may be considered by the CQI control entity 12G in the Node B 12 is the uplink cell-level load and utilization. For example, in that each CQI report consumes some bandwidth, only a sub-set of UEs 10 may be able to simultaneously transmit CQI reports. If the uplink data load and utilization is high in the cell, then the CQI control entity 12G may reduce the CQI bandwidth in the cell (thus, also per UE 10) in order to achieve a best or optimum tradeoff of data capacity in view of uplink and downlink performance.

A further criterion of interest that may be considered by the CQI control entity 12G in the Node B 12 is knowledge of the QoS service profiles and priorities of the UEs 10. For example, by combining load measurements with knowledge of the QoS service profile for the UEs 10 (preferably separated into uplink and downlink traffic), the CQI control entity 12G may arrive at a set the CQI parameters and/or reporting rate that have the least impact on the QoS needs of a particular UE 10 and/or on QoS needs of a population of UEs 10.

Further in this regard, it may be appreciated that is not necessarily disadvantageous to send more CQI-related information in the uplink, possibly limiting the uplink data capacity, if the data is of low importance. Conversely, it may be further appreciated that if, for example, VoIP traffic constitutes most of the uplink capacity in the cell it may be desirable to target a reduction in, for example, best-effort data capacity in the downlink by reducing the CQI rate.

In order to estimate the downlink load the Node B 12 may use direct measurements on the UE buffers (MAC-layer DL data buffers) and possibly also consider the scheduled resources (MAC). To estimate the uplink load and radio conditions the Node B 12 may use UL (MAC) data buffer reports from the UEs 10, and possibly also ACK/NACK reports (see FIG. 6). If available, the Node B 12 may also use reports of transmitted power from the UE 10 and/or knowledge of these powers if given in absolute terms at the Node-B 12, and also measurements on pilots transmitted by the UE 10 (i.e., measuring the pilot power(s) as received at the Node B 12). The foregoing techniques for estimating UP/DL loading are exemplary, and are not intended to be limiting.

The foregoing procedures may be implemented in a number of ways. For example, one may introduce algorithm parameters and/or thresholds such that the network operator may configure the network 1 in a desired manner. For example, the network 1 may be configured so as to facilitate a “battery-friendly” network (from the perspective of the UEs 10), or the network 1 may be configured more aggressively so as to provide high downlink data rates. Some non-limiting examples of such “thresholds” can include the following:
A) A first exemplary threshold is a maximum relative transmission power in the uplink that can be dedicated to CQI signaling (e.g., about 60% of the UE 10 transmission power), conditioned on the required data load being less than the remaining power (e.g., ≦ about 40%). As was mentioned above, the actual threshold value may be dependent on the QoS service profile as well.
B) A second exemplary threshold is an estimated downlink link/cell spectral efficiency gain that can be achieved by increasing CQI bandwidth to a next level, and the resulting reduction in uplink load. For example, if the efficiency gain is less than about 5% it may be preferred to instead operate so as to conserve UE 10 battery power.

There are a number of advantages that can be realized by the use of these further exemplary embodiments of this invention. For example, the use of these further exemplary embodiments of this invention provide a means for the network operator to have control over the balance between an expected gain in the downlink as a function of the available (and actually used) uplink resources. The use of these further exemplary embodiments of this invention also provide relatively simple and readily implemented procedures that can be applied to various types of CQI reporting schemes. The use of these further exemplary embodiments of this invention is also advantageous since the CQI reporting method may reasonably be expected to be changed/updated but occasionally, thereby minimizing any additional signaling overhead.

FIG. 8 is a logic flow diagram that is illustrative of operation of the CQI Control entity or function 12G shown in FIGS. 1 and 6, and is further expressive of a method in accordance with the exemplary embodiments of this invention. At Block 8A the method involves the CQI Control entity 12G considering at least one of downlink UE load and possibly consumed resources, uplink UE load and possibly consumed resources, downlink cell-level load and possibly consumed resources, uplink cell-level load and possibly consumed resources, and possibly also QoS service profiles and priorities. At Block 8B the method further includes establishing UE CQI reporting-related parameters. At Step 8C the method further includes transmitting the established CQI reporting-related parameters to the UE 10.

In the method the Node B 12 may estimate downlink load using a measurements of a UE DL buffer, and may consider scheduled resources. In the method the Node B 12 may estimate uplink load, and possibly radio conditions, using an UL data buffer report from the UE, and may also consider an ACK/NACK report. In the method the Node B 12 may use a report of transmitted power from the UE, and/or knowledge of the power. In the method the Node B 12 may also consider a measurement of pilot power transmitted by the UE 10.

In the method there may be a configuration of the network using at least one threshold, where an exemplary threshold is a maximum relative transmission power in the UL that may be dedicated to CQI signaling, conditioned on the required data load being less than the remaining power, and where another exemplary threshold is an estimated DL link/cell spectral efficiency gain that is achievable by increasing CQI bandwidth to a next level, and a resulting reduction in UL load.

The operation of Block 8A may also involve a consideration of other parameters, such as CQI rate of change and/or and estimation of uplink channel quality conditions.

The operation of Block 8B may involve establishing a CQI reporting rate and/or a content of a CQI report. As a non-limiting example, the content of the CQI report may be specified as discussed above with respect to FIG. 5, wherein at Block 5A the CQI CNT 12G establishes the set of UE CQI-related parameters for dynamically adjusting CQI reporting accuracy and bandwidth usage, where the CQI-related parameters comprise the N_{ActiveRB} (a bit mask for specifying a Number of Active Resource Blocks), the variable Y (the clustering factor), and the value of R_{CQI} (for indicating how many representation bits are available per signaling N_{activeRB}/Y group).

FIG. 8 is also representative of a computer program product (12C) that may reside on a tangible memory medium (e.g., the memory 12B) of the Node B 12, and that is executed by at least one data processor of the Node B 12 to perform operations of considering at least one of downlink UE load (and possibly consumed resources), uplink UE load (and possibly consumed resources), downlink cell-level load (and possibly consumed resources), uplink cell-level load (and possibly consumed resources), and possibly also QoS service profiles and priorities; establishing UE CQI reporting-related parameters; and causing the established CQI reporting-related parameters to be transmitted to one or more UEs 10 in the cell of the Node B 12.

It can be appreciated that FIG. 8 may also be viewed as interconnected logic blocks for implementing at least in part the CQI CNT 12G, and includes a unit and means for considering at least one of downlink UE load (and possibly consumed resources), uplink UE load (and possibly consumed resources), downlink cell-level load (and possibly consumed resources), uplink cell-level load (and possibly consumed resources), and possibly also QoS service profiles and priorities; a unit and means for establishing UE CQI reporting-related parameters; and a unit and means for causing the established CQI reporting-related parameters to be transmitted to one or more UEs 10 in the cell of the Node B 12.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, logic flow diagrams, message flow diagrams, or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
sending to a user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity; and
receiving CQI reporting from the user equipment in accordance with the CQI related parameters.

2. The method of claim 1, where the information input comprises at least one of downlink user equipment load; uplink user equipment load; downlink cell level load; and uplink cell level load.

3. The method of claim 1, where the information input comprises a QoS service profile and priority

4. The method of claim 1, where the information input comprises at least one of a report of transmitted power from the user equipment; and a measurement of pilot power transmitted by the user equipment.

5. The method of claim 1, where the information input comprises at least one of a CQI rate of change and an estimation of uplink channel quality.

6. The method of claim 2, where the downlink user equipment load is estimated using a user equipment downlink buffer.

7. The method of claim 2, where the uplink user equipment load is estimated using at least one of an uplink data buffer report from the user equipment and an ACK/NACK report.

8. The method of claim 1, where the information input comprises an estimate of downlink link/cell spectral efficiency gain achievable by increasing CQI bandwidth and a resulting reduction in an uplink load.

9. The method of claim 1, where the CQI related parameters specified for the user equipment control thresholds comprising a maximum relative transmission power in an uplink that is dedicated for CQI signaling.

10. The method of claim 9, where the maximum relative transmission power uplink is conditioned on a required data load being less than a remaining power.

11. The method of claim 1, where the parameters for dynamically controlling the CQI reporting comprise:
a bit mask for specifying a number of active resource blocks (N_{ActiveRB}), where the bit mask identifies a physical resource block (PRB) the user equipment is to conduct measurements on;
a value (Y), where Y denotes how many neighboring PRBs are to be grouped together and averaged in the measurements; and
a number indicating an amount of representation bits (R_{CQI}) available per signaling group.

12. The method of claim 11 where the size of the CQI reporting is defined as N_{CQI}=M_{CQI}+(length{N_{activeRB}}Y}×R_{CQI}, where M_{CQI} is a number of bits allocated for signaling of a metric representing the average channel quality.

13. The method of claim 12, where the metric comprises an average relative signal to interference ratio (SINR) value.

14. The method of claim 1 where the CQI related parameters are sent to a plurality of user equipment.

15. The method of claim 1, where the CQI related parameters are configured for an individual user equipment.

16. The method of claim 1, where the reporting accuracy mode includes one of a distributed measurement mode, a frequency domain bit map mode, and N-bit frequency domain reports.

17. The method of claim 1, where the CQI related parameters comprise one of event based, time domain interval, and physical CQI reporting.

18. The method of claim 1, where the CQI related parameters are sent to the user equipment on at least one of point to point, point to multipoint, and down link control signaling.

19. The method of claim 1, where the information input comprises at least one of a QoS service profile and priority; a report of transmitted power from the user equipment; and a measurement of pilot power transmitted by the user equipment.

20. A method, comprising:
receiving at a user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity;
generating CQI reporting in accordance with the CQI related parameters; and
sending the CQI reporting.

21. The method of claim 20, where the CQI related parameters are received by the user equipment on at least one of point to point, point to multipoint, and down link control signaling.

22. The method of claim 20, where the parameters for dynamically controlling the CQI reporting comprise:
a bit mask for specifying a number of active resource blocks (N_{ActiveRB}), where the bit mask identifies a physical resource block (PRB) the user equipment is to conduct measurements on;
a value (Y), where Y denotes how many neighboring PRBs are to be grouped together and averaged in the measurements; and
a number indicating an amount of representation bits (R_{CQI}) available per signaling group.

23. The method of claim 22 where the size of the CQI reporting is defined as N_{CQI}=M_{CQI}+(length{N_{activeRB}}/Y}×R_{CQI}, where M_{CQI} is a number of bits allocated for signaling of a metric representing the average channel quality.

24. A computer readable medium encoded with a computer program executable by a processor to perform actions comprising:
sending to a user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity; and
receiving CQI reporting from the user equipment in accordance with the CQI related parameters.

25. The computer readable medium encoded with a computer program of claim 24, where the information input comprises at least one of downlink user equipment load; uplink user equipment load; downlink cell level load; and uplink cell level load.

26. The computer readable medium encoded with a computer program of claim 24, where the information input comprises a QoS service profile and priority.

27. The computer readable medium encoded with a computer program of claim 24, where the information input comprises at least one of a report of transmitted power from the user equipment and a measurement of pilot power transmitted by the user equipment.

28. The computer readable medium encoded with a computer program of claim 24, where the information input comprises at least one of a CQI rate of change and an estimation of uplink channel quality.

29. The computer readable medium encoded with a computer program of claim 25, where the downlink user equipment load is estimated using a user equipment downlink buffer.

30. The computer readable medium encoded with a computer program of claim 25, where the uplink user equipment load is estimated using at least one of an uplink data buffer report from the user equipment and an ACK/NACK report.

31. The computer readable medium encoded with a computer program of claim 24, where the information input comprises an estimate of downlink link/cell spectral efficiency gain achievable by increasing CQI bandwidth and a resulting reduction in uplink load.

32. The computer readable medium encoded with a computer program of claim 24, where the CQI related parameters specified for the user equipment control thresholds comprising a maximum relative transmission power in an uplink that is dedicated for CQI signaling;

33. The computer readable medium encoded with a computer program of claim 32, where the maximum relative transmission power uplink is conditioned on a required data load being less than a remaining power

34. The computer readable medium encoded with a computer program of claim 24, where the parameters for dynamically controlling the CQI reporting comprise:
a bit mask for specifying a number of active resource blocks (N_{ActiveRB}), where the bit mask identifies a physical resource block (PRB) the user equipment is to conduct measurements on;
a value (Y), where Y denotes how many neighboring PRBs are to be grouped together and averaged in the measurements; and
a number indicating an amount of representation bits (R_{CQI}), available per signaling group.

35. The computer readable medium encoded with a computer program of claim 34, where the size of the CQI reporting is defined as N_{CQI}=M_{CQI}+(length{N_{activeRB}}/Y}×R_{CQI}, where M_{CQI} is a number of bits allocated for signaling of a metric representing the average channel quality.

36. The computer readable medium encoded with a computer program of claim 35, where the metric comprises an average relative signal to interference ratio (SINR) value.

37. The computer readable medium encoded with a computer program of claim 24, where the CQI related parameters are sent to a plurality of user equipment.

38. The computer readable medium encoded with a computer program of claim 24, where the CQI related parameters are configured for an individual user equipment.

39. The computer readable medium encoded with a computer program of claim 24, where the reporting accuracy mode includes one of a distributed measurement mode, a frequency domain bit map mode, and N-bit frequency domain reports.

40. The computer readable medium encoded with a computer program of claim 24, where the CQI related parameters comprise one of event based, time domain interval, and physical CQI reporting.

41. The computer readable medium encoded with a computer program of claim 24, where the CQI related parameters are sent to the user equipment on at least one of point to point, point to multipoint, and down link control signaling.

42. The computer readable medium encoded with a computer program of claim 24, where the information input comprises at least one of a QoS service profile and priority; a report of transmitted power from the user equipment; and a measurement of pilot power transmitted by the user equipment.

43. A computer readable medium encoded with a computer program executable by a processor to perform actions of a user equipment comprising:
receiving at the user equipment information comprising channel quality indicator (CQI) related parameters for dynamically controlling CQI reporting of the user equipment, where the CQI related parameters are specified for the user equipment in response to information input to a network node and where the specified CQI related parameters comprise a reporting accuracy mode adapted for an available signaling capacity;
generating CQI reporting in accordance with the CQI related parameters; and
sending the CQI reporting.

44. The computer readable medium encoded with a computer program of claim 43, where the CQI related parameters are received by the user equipment in signaling comprising at least one of point to point, point to multipoint, and down link control.

45. The computer readable medium encoded with a computer program of claim 43, where the parameters for dynamically controlling the CQI reporting comprise:
a bit mask for specifying a number of active resource blocks (N_{ActiveRB}), where the bit mask identifies a physical resource block (PRB) the user equipment is to conduct measurements on;
a value (Y), where Y denotes how many neighboring PRBs are to be grouped together and averaged in the measurements; and
a number indicating an amount of representation bits (R_{CQI}) available per signaling group.

46. The computer readable medium encoded with a computer program of claim 45, where the size of the CQI reporting is defined as N_{CQI}=M_{CQI}+(length{N_{activeRB}}/Y}×R_{CQI}, where M_{CQI} is a number of bits allocated for signaling of a metric representing the average channel quality.

47. An apparatus, comprising:
a wireless transmitter coupled to a processor configured to send to a user equipment information comprising channel quality indicator (CQI) related parameters for dynamically controlling CQI reporting of the user equipment, where the CQI related parameters are specified for the user equipment in response to information input to the apparatus and where the specified CQI related parameters comprise a reporting accuracy mode adapted for an available signaling capacity; and
a receiver for receiving CQI reporting from the user equipment in accordance with the CQI related parameters.

48. The apparatus of claim 47, where the information input comprises at least one of downlink user equipment load; uplink user equipment load; downlink cell level load, and uplink cell level load.

49. The apparatus of claim 47, where the information input comprises a QoS service profile and priority

50. The apparatus of claim 47, where the information input comprises at least one of a report of transmitted power from the user equipment and a measurement of pilot power transmitted by the user equipment.

51. The apparatus of claim 47, where the information input comprises at least one of a CQI rate of change and an estimation of uplink channel quality.

52. The apparatus of claim 48, where the downlink user equipment load is estimated using a user equipment downlink buffer.

53. The apparatus of claim 48, where the uplink user equipment load is estimated using at least one of an uplink data buffer report from the user equipment and an ACK/NACK report.

54. The apparatus of claim 47, where the information input comprises at least one of a QoS service profile and priority; a report of transmitted power from the user equipment; and a measurement of pilot power transmitted by the user equipment.

55. The apparatus of claim 47, where the information input comprises an estimated downlink link/cell spectral efficiency gain achievable by increasing CQI bandwidth and a resulting reduction in uplink load.

56. The apparatus of claim 47, where the CQI related parameters specified for the user equipment control thresholds comprising a maximum relative transmission power in an uplink that is dedicated for CQI signaling.

57. The apparatus of claim 56, where the maximum relative transmission power uplink is conditioned on a required data load being less than a remaining power.

58. The apparatus of claim 47, where the parameters for dynamically controlling the CQI reporting comprise:
a bit mask for specifying a number of active resource blocks (N_{ActiveRB}), where the bit mask identifies a physical resource block (PRB) the user equipment is to conduct measurements on;
a value (Y), where Y denotes how many neighboring PRBs are to be grouped together and averaged in the measurements; and
a number indicating an amount of representation bits (R_{CQI}) available per signaling group.

59. The apparatus of claim 58, where the size of the CQI reporting is defined as N_{CQI}=M_{CQI}+(length{N_{activeRB}}I/Y}×R_{CQI}, where M_{CQI} is a number of bits allocated for signaling of a metric representing the average channel quality.

60. The apparatus of claim 59, where the metric comprises an average relative signal to interference ratio (SINR) value.

61. The apparatus of claim 47, where the CQI related parameters are sent to a plurality of user equipment.

62. The apparatus of claim 47, where the CQI related parameters are configured for an individual user equipment.

63. The apparatus of claim 47, where the reporting accuracy mode includes one of a distributed measurement mode, a frequency domain bit map mode, and N-bit frequency domain reports.

64. The apparatus of claim 47, where the CQI related parameters comprise one of event based, time domain interval, and physical CQI reporting.

65. The apparatus of claim 47, where the CQI related parameters are sent to the user equipment on at least one of point to point, point to multipoint, and down link control signaling.

66. An apparatus comprising:
a wireless receiver configured to receive information comprising channel quality indicator (CQI) related parameters for dynamically controlling CQI reporting of a user equipment, where the CQI related parameters are specified for the user equipment in response to information input to the apparatus and where the specified CQI related parameters comprise a reporting accuracy mode adapted for an available signaling capacity;
a processor configured to generate CQI reporting in accordance with the CQI related parameters; and
a transmitter configured to send the generated CQI reporting.

67. The apparatus of claim 66, where the parameters for dynamically controlling the CQI reporting comprise:
a bit mask for specifying a number of active resource blocks (N_{ActiveRB}), where the bit mask identifies a physical resource block (PRB) the user equipment is to conduct measurements on;
a value (Y), where Y denotes how many neighboring PRBs are to be grouped together and averaged in the measurements; and
a number indicating an amount of representation bits (R_{CQI}) available per signaling group.

68. The apparatus of claim 67, where the size of the CQI reporting is defined as N_{CQI}=M_{CQI}+(length{N_{activeRB}}/Y}×R_{CQI}, where M_{CQI} is a number of bits allocated for signaling of a metric representing the average channel quality.

69. An apparatus, comprising:
means for sending to a user equipment information comprising channel quality indicator (CQI) related parameters for dynamically controlling CQI reporting of the user equipment, where the CQI related parameters are specified for the user equipment in response to information input to the apparatus and where the specified CQI related parameters comprise a reporting accuracy mode adapted for an available signaling capacity; and
means for receiving CQI reporting from the user equipment in accordance with the CQI related parameters.

70. The apparatus of claim 69, where
the means for sending comprises a transmitter coupled to a processor; and
the means for receiving comprises a receiver.
